(19) United States
(12) Patent Application Publication
(10) Pub. No.: US 2009/0307302 A1
(43) Pub. Date: Dec. 10, 2009

(54) System and Method for Providing Data from a Server to a Client

(75) Inventors: Joseph A. Tennant, Wadsworth, OH (US); Brian W. Earley, Bellville, OH (US); Peter R. Zito, Akron, OH (US); Robert C. Fellows, Medina, OH (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: SNAP-ON INCORPORATED, Kenosha, WI (US)

(21) Appl. No.: 12/135,007

(22) Filed: Jun. 6, 2008

(51) Int. Cl. G06F 15/16

(52) U.S. Cl. 709/203

(57) ABSTRACT

A method and system is provided for a server to provide data to a client. A client user requests presentation of a data file that is associated with time-to-live data and a hash. If the time-to-live data is not expired, the client presents to the user a data file stored at the client. If the time-to-live data is expired, the client requests the server to send the hash associated with the latest version of the data file stored at the server. The client determines whether the hashes match. If the hashes match, the client presents the data file stored at the client. If the hashes do not match, the client requests that the server provide the client with the latest version of the data file. After receiving the latest version of the data file, the client presents to the user the latest version of the data file.

### BACKGROUND

Personal computers increase user efficiency in many ways. However, prior to the widespread use of the Internet, a computer user had limited options for automatically updating the data (e.g., information) on his computer from outside sources such as a server outside of the user's private network. A user typically had to manually upload updated files onto his computer using extrinsic data storage mediums such as CD-ROMs or floppy disks. Or worse, the user would have to go through paper files and update the computer files manually.

If a user depended on operating with the most current information, the user risked damage to his operations (e.g., business operations) by using obsolete information while waiting for the most current information. For example, an automobile technician risked using obsolete service parts information until the technician received from a manufacturer a CD-ROM containing the most current service parts information for uploading onto the technician's computer. Yet with the advent of the Internet, computers connected to the Internet took on a whole new level of functionality where digital information could be exchanged and updated automatically.

By being connected to a data communication network, a user is able to have the most current information loaded onto his computer. Whether a user's computer is connected to a local area network (“LAN”) or a wide area network (“WAN”), a central server is useful for storing updated data files to be loaded onto the computer. In the field of network communications, a server is a computer system that receives requests from a client computer and sends an appropriate reply back to the client computer. And a client computer is the computer system that sends the requests to a server and waits to receive a response (e.g., updated information) from the server.

A widely-used server-to-client computer data updating technique is a push update. A push update is automatically initiated by a server to force updated information onto a client computer within its network. The server can automatically initiate the push update when it determines updates are available. While this is an automated process that requires no initiation from the client computer, the push update has its disadvantages. During a push update, a client computer cannot receive the updated information if the client computer is turned off. In this regard, the push update is delayed, or worse, unsuccessful.

Another server-to-client computer data updating technique is a pull update. Unlike the push update, a pull update is initiated by a client computer and may be manually initiated by the user. Because a pull update is initiated when the client computer is turned on, it inherently solves the problem in carrying out a push update when the client computer is turned off. However the pull update has disadvantages as well.

For instance, because a pull update is usually initiated by a user that operates the client computer, there is room for human error. The user may forget or choose not to check the server for updated data, which may increase the time that the client computer contains obsolete data. Additionally, manual pull updates initiated from a client computer will often result in wasted computer processing power due to unnecessary searching of a server that hasn't stored any updated information.

### SUMMARY

A method and system is provided for a client to automatically determine whether to pull data from a server and for the client to use the pulled data to automatically determine whether to pull additional data from the server so as to provide the client with updated data. The determinations may be carried out in response to a user requesting data of a particular data file stored at the client. The updated data may be presented to a user of the client in response to the user request. In this way, the user reduces the risk of being presented with obsolete data that is stored at the client.

In one respect, an embodiment may be arranged in the form of a method. The method includes, at data storage of a client, maintaining (i) a first version of a data file, (ii) a file identifier that identifies the data file, (iii) a time-to-live indicator that is associated with the data file, and (iv) a first hash that is associated with the first version of the data file. The method also includes (i) receiving a first request for the data file, (ii) in response to receiving the first request for the data file, determining whether the time-to-live indicator has expired, wherein in response to determining that the time-to-live indicator has not expired, presenting the first version of the data file to a requestor of the data file, otherwise, in response to determining that the time-to-live indicator has expired, transmitting a hash request to a server, and (iii) the client, after transmitting the hash request, receiving from the server the first hash, and then, responsively presenting the first version of the data file via a user interface.

In another respect, an embodiment may be arranged in the form of another method. The other method includes, at data storage of a client, maintaining (i) a first version of a data file, (ii) a file identifier that identifies the data file, (iii) a time-to-live indicator that is associated with the data file, and (iv) a first hash that is associated with the first version of the data file. The other method also includes (i) receiving a first request for the data file, (ii) in response to receiving the first request for the data file, determining whether the time-to-live indicator has expired, wherein in response to determining that the time-to-live indicator has not expired, presenting the first version of the data file to a requestor of the data file, otherwise, in response to determining that the time-to-live indicator has expired, transmitting to a server the file identifier and the first hash, and (iii) the client, after transmitting the file identifier and the first hash, receiving from the server an indication that the first version of the data file is a latest version of the data file, and then, responsively presenting the first version of the data file via a user interface.

These as well as other aspects and advantages will become apparent to those of ordinary skill in the art by reading the following detailed description, with reference where appropriate to the accompanying drawings.

### BRIEF DESCRIPTION OF DRAWINGS

Various examples of embodiments arranged as a method or a system are described herein with reference to the following drawings, in which:

FIG. 1 is a block diagram of a network architecture in which exemplary methods and systems may be implemented;

FIG. 2 is a block diagram of a client in accordance with the exemplary methods and systems;

FIG. 3 is a block diagram of a server in accordance with the exemplary methods and systems;

FIGS. 4 and 5 depict a flow chart including a set of functions that may be carried out in accordance with the exemplary methods and systems;

FIG. 6 depicts an example of a hash request message that may be transmitted from a client to a server;

FIG. 7 depicts an example of a hash response message that may be transmitted from a server to a client;

FIG. 8 depicts an example of a file request message that may be transmitted from a client to a server; and

FIG. 9 depicts an example of a file transmission message that may be transmitted from a server to a client.

### DETAILED DESCRIPTION

### 1. Overview

This description describes exemplary methods and systems for providing data to a client from a server. For purposes of this description, the word “exemplary” is used herein to mean “serving as an example, instance, or illustration.” Any embodiment or element described herein as “exemplary” is not necessarily to be construed as preferred or advantageous over other embodiments or elements.

In an exemplary embodiment arranged as a method, providing the data to the client from the server may include providing the client with initial data. The initial data provided to the client may be maintained at data storage of the client (i.e., “client data storage”). After the client receives the initial data, the server may provide the client with updated data (e.g., new data and/or modified data). Providing the client with updated data may be carried out in response to (i) a user of the client requesting a given portion of the initial data maintained in the client data storage, (ii) the client determining that time-to-live data associated with the requested data has expired, (iii) the client determining that a hash associated with the data maintained in the client data storage is different than a hash stored at data storage of the server (i.e., “server data storage”), and (iv) requesting the server to provide updated data that is associated with the different hash. The client may be operable to present at least a portion of the initial data and/or at least a portion of the updated data to a user of the client.

For purposes of this description, a “hash” may include a short value calculated from digital data (e.g., the data of a given data file that includes initial data) that serves to distinguish the digital data from other data (e.g., the data of one or more data files that include updated data). As an example, a hash associated with the given file may include a cyclic redundancy check (CRC) that is calculated using the given file. The hash (e.g., the CRC) may be calculated by the server or some other device that provides the given file to the server. Other examples of a hash and other examples of calculating a hash are also possible.

For purposes of this description, the initial data and updated data provided to the client may include user data. The user data may include data that would typically be presented to a user of the client, as well as data that would typically not be presented to a user of the client.

In one respect, the user data may include assembly parts data for any of a variety of assemblies. Each assembly may include two or more components (e.g., service parts, or more simply, “parts”). Each part may be represented by a portion of the assembly parts data. As an example, the assemblies may include (i) a vehicle such as an automobile, a motorcycle, a bicycle, or an airplane, (ii), a television, (iii) a printer, such as a laser jet printer, or (iv) a lap top computer. A person having ordinary skill in the art will understand that other examples of assemblies are also possible. Assembly parts data may be stored electronically in client data storage and/or in server data storage. Assembly parts data may be referred to as electronic assembly parts catalog data or more simply, electronic parts catalog (EPC) data.

In another respect, the user data may include data arranged as any of a variety of file types. Each file represented by a given file type may comprise a binary file. Each file including user data may include a link to another file stored at client data storage and/or at server data storage. A user accessing a particular file stored at the client data storage may access another file stored at the client data storage by selecting a link to the other file.

The file types may include a “page-file-type” file that includes a parts list and related data for one or more assemblies. Table 1 illustrates exemplary data that may be included in a page-file-type file identified as “carburetor1.page.” Although the data of the “carburetor1.page” file is shown in a table, presentation of some or all of the data of the file may occur as a table or in a manner other than a table.

The descriptions listed in the left-most column of Table 1 identify commonly-known names for a carburetor assembly and for parts of the carburetor assembly. For other page-file-type files, the “Description” data may identify commonly-known names for parts of an assembly other than a carburetor.

TABLE 1
Page-file-type data

| Description | Part No. | Notes | Ref. No. | Price |
|---|---|---|---|---|
| Carburetor | 90112345 | Used on assembly | 12345 | $345.00 |
| | | model numbers X123 | | |
| | | and Z171 | | |
| Fuel Jet | 90112346 | Quantity of 2 per | 12346 | $14.99 |
| | | carburetor | | |
| Float | 90123890 | Quantity of 1 per | 23890 | $7.88 |
| | | carburetor | | |
| Metering Valve | 90223562 | | 23562 | $8.28 |
| Gasket | 90252525 | No gasket sealant | 52525 | $3.29 |
| | | required | | |

The data in each row of Table 1, other than the top row, may be associated with a respective assembly or a respective assembly part. In this regard, each assembly or assembly part identified in the left-most column may be associated with (i) a part number, such as a part number a client user (e.g., a retailer) can use to purchase the assembly or assembly part, (ii) a note that may provide additional information regarding the assembly or assembly part, (iii) a reference number that is associated with an identical reference number in another data file, such as a hot-spot-type file described below, and (iv) a price, such as a sales price charged by a distributor that sells the assembly or assembly part. The “Notes” element associated with the Metering Valve is left intentionally blank to indicate that some parts identified in a page-file-type file may not be associated with any notes specific to that part. Similarly, other elements (e.g., Ref. No.) of Table 1 might be left blank for one or more of the identified parts. Other examples of data that may be included in a page-file-type file are also possible.

Additionally, a given page-file-type file may be associated with one or more page notes. Each page note may be associated with all of the information in the given page-file-type file. For example, a page note for the “carburetor1.page” file may include a page note that indicates that some or all of the assembly parts or assemblies identified in the file are viewable in an image file entitled “carburetor1.tiff.” As another example, a page note for the “carburetor1.page” file may include a page note that indicates a hot-spot-file-type file (described below) that is associated with some or all of the assembly parts or assemblies identified in the page-file-type file. As yet another example, a page note for the “carburetor1.page” file may include a page note that includes a legend associated with the page-file-type file, such as a legend that defines abbreviations and/or acronyms recited in the data of the page-file-type file. Other examples of page notes are also possible.

The file types may also include an “image-file-type” file that includes image data for presenting to a user of the client a still image and/or a sequence of images (e.g., a video). Image-file-type files may be named as a file having a file extension such as “pdf,” “tiff,” “gif,” “png,” ‘jpg,” “jpeg,” “bmp,” “mpeg, or some other file extension. An image-file-type file identified as “carburetor1.tiff” may include data for presenting an image of a carburetor used on assemblies having a model numbers X123 or Z171. As an example, the model numbers X123 and Z171 may be associated with respective models of motorcycles built by a given motorcycle manufacturer.

The file types may also include a “hot-spot-file-type” file. Each hot-spot-file-type file may include coordinate information that is associated with all or a portion of an image presentable by a given image file (e.g., carburetor1.tiff). As an example, the coordinate information may identify distinct areas of an image of the “carburetor1.tiff” file, such as distinct areas of the image illustrating an entire carburetor, a fuel jet, a float, a metering valve, and a gasket. Each distinct area may be associated with a reference number listed in a page-file-type file such as “carburetor1.page” (see the Table 1 column identified as Ref. No.). In this way, if a user selects a given area of the image, the reference number associated with the given area may be used to retrieve information of a page-file-type file (e.g., carburetor1.page) that is also associated with the reference number.

The file types may also include a “catalog-file-type” file that includes data that is associated with a plurality of page-file-type files. A catalog-file-type file may include data of a logical grouping of a plurality of page-file-type files, such as a logical grouping of all page-file-type files that relate to a given assembly (e.g., a carburetor).

The file types may also include a “navigation-file-type” file. A navigation-file-type file may include data for organizing a plurality of files arranged as catalog-type-files. As an example, a navigation-file-type file identified as modelz171.nav may include data associated with a plurality of catalog-file-type files that include parts data for assemblies that can be used on a vehicle having a model number Z171.

In yet another respect, user data may include metadata (e.g., data about other data, and in particular, data about other user data). Table 2 depicts exemplary metadata. Each column in Table 2 contains a different category of metadata. The top row of Table 2 identifies exemplary categories of metadata, namely, a file identifier, a data type, a hash, time-to-live (TTL) data, and a file date. User data may include other categories of metadata as well.

TABLE 2
Metadata

| | | | | File Date |
|---|---|---|---|---|
| File Identifier | Data Type | Hash | Time-to-live Data | (MM/DD/YYYY) |
| carburetor1.tiff | Image-file | 3C4F10A8 | 30 days | 01/01/2009 |
| carburetor1.page | Page-file | 85AB603E | 30 days | 01/02/2009 |
| model171.nav | Navigation-file | 0466C315 | 7 days | 10/31/2008 |
| 412A39 | Hot-Spot-file | C30812F4 | 14 days | 11/12/2008 |

Each row of Table 2, other than the top row, includes data that is associated with a given set of user data, such as a given data file. For example, the data in the second row of Table 2 is associated with the file identified as “carburetor1.tiff.” By way of example, the carburetor1.tiff file is associate with a file identifier, a data type (e.g., a file type), a hash, time-to-live (TTL) data, and a file date.

### 2. Exemplary Architecture

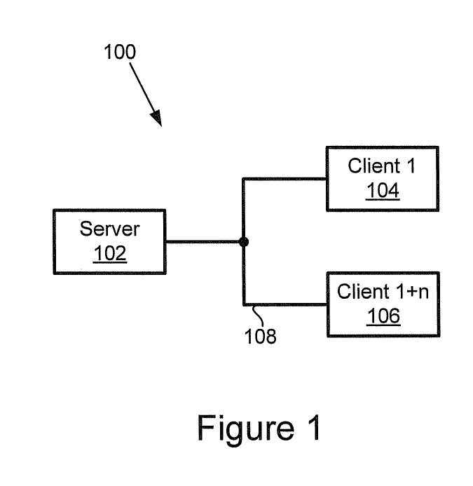

FIG. 1 depicts a block diagram of an exemplary network architecture 100 in which the exemplary embodiments may be implemented. It should be understood that this and other arrangements described herein are set forth only as examples. Those skilled in the art will appreciate that other arrangements and elements (e.g., machines, interfaces, functions, orders, and groupings of functions, etc.) can be used instead, and that some elements may be omitted altogether. Further, many of the elements described herein are functional entities that may be implemented as discrete or distributed components or in conjunction with other components, and in any suitable combination and location. Further, various functions described herein as being performed by one or more elements may be carried out by hardware, firmware, and/or software (e.g., computer-readable program instructions that are stored at data storage and are executable by a processor).

As depicted in FIG. 1, network architecture 100 includes a server 102, clients 104, 106, and a communication network 108. An exemplary system may include network architecture 100 or any elements of network architecture 100. Although network architecture 100 is depicted with two clients, a person having ordinary skill in the art will understand that the exemplary methods and systems described herein may be implemented in a network architecture having a quantity of clients other than two, such as one client or more than two clients. Similarly, a person having ordinary skill in the art will understand that one or more other servers may serve a plurality of other clients to carry out the exemplary methods.

Server 102 is operable to perform services for client 102, 104. For example, server 102 may provide user data to clients 104, 106. Clients 104, 106 are operable to request server 102 to perform services for clients 104, 106 respectively. For example, clients 104, 106 may request server 102 to provide user data for use at clients 104, 106, respectively. Additionally, clients 104, 106 are operable to receive the requested data from server 102 and to present at least a portion of the received user data to a user of clients 104, 106, respectively.

By way of example, server 102 may provide assembly parts data to client 104, 106. In accordance with this example, server 102 may be operated by and/or for a manufacturer of assemblies and/or assembly parts that are represented by the assembly parts data. Additionally, in accordance with this example, clients 104, 106 may be operated by and/or for (i) a retailer that sells assemblies and/or assembly parts to a user of the assemblies or assembly parts, and/or (ii) an agent (e.g., a wholesaler) that purchases assemblies and/or assembly parts from the manufacturer and then sells the assemblies and/or assembly parts to the retailer.

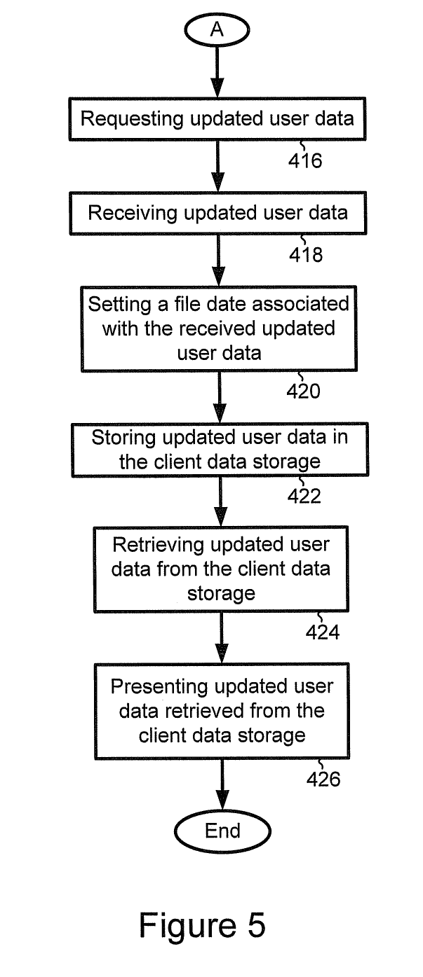

Communication network 108 is operable to transport communications between server 102 and clients 104, 106 (e.g., operable to transport communications from server 102 to clients 104, 106 and/or from clients 104, 106 to server 102). The communications transported between server 102 and clients 104, 106 may include communications such as (i) a request for user data, such as a hash request message and a file request message, (ii) user data, such as data within a hash response message and a file transmission message, (iii) an acknowledgment that the server 102 has received a communication from client 104 or client 106, and (iv) an acknowledgment that client 104 or client 106 has received a communication from server 102. Examples of a hash request message 600, a hash response message 700, a file request message 800, and a file transmission message 900 are illustrated in FIGS. 6, 7, 8 and 9, respectively. These messages and figures are described below.

Communication network 108 may comprise one or more communication links. In one respect, communication network 108 may comprise a wireless communication link, a wired communication link, or some combination of one or more wireless communications links and/or one or more wired communication links. In another respect, communication network 108 may comprise a circuit-switched network link, a packet-switched network link, or some combination of one or more circuit-switched network links and/or one or more packet-switched network links. In yet another respect, communication network 108 may comprise a private network link, a public network link, or some combination of one or more private network links and/or one or more public network links. Additionally, communication network 108 or some portion of communication network 108 may comprise the Internet or some portion of the Internet. In this regard, communication network 108 may also transport communications other than those that are transported between server 102 and clients 104, 106.

In the embodiments in which communication network 108 includes a plurality of communication links, any two or more of the communication links may be connected via a network element, such as a router, a gateway that coverts communications in a first protocol to communications in a second protocol, or some other network element. Other examples of the communication links and other examples of the network elements that connect two or more communication links are also possible.

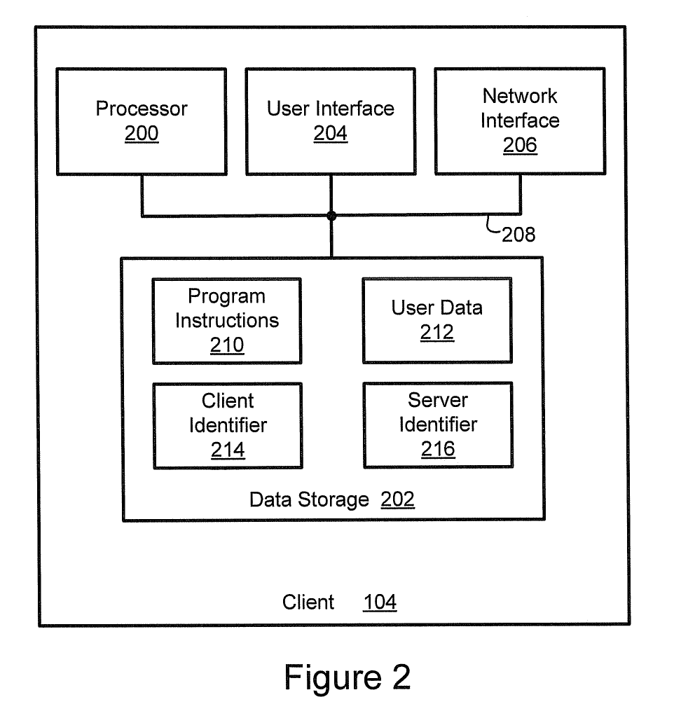

Next, FIG. 2 depicts a block diagram illustrating details of client 104. As depicted in FIG. 2, client 104 may include a processor 200, data storage 202, a user interface 204, and a network interface 206, all of which may be linked together via a system bus, network, or other connection mechanism 208. An exemplary system and/or apparatus may include client 104 or any elements of client 104. Client 106 and/or one or more other clients (not shown) may be arranged in a configuration similar to the configuration of client 104 illustrated in FIG. 2.

For purposes of this description, a processor, such as processor 200, may comprise one or more general purpose processors (e.g., INTEL microprocessors) and/or one or more special purpose processors (e.g., digital signal processors). The processor may execute computer-readable program instructions that are stored in data storage.

For purposes of this description, data storage, such as data storage 202, may comprise a computer-readable storage medium readable by a processor. The computer-readable storage medium may comprise volatile and/or non-volatile storage components, such as optical, magnetic, organic or other memory or disc storage, which can be integrated in whole or in part with a processor. For purposes of this description, data storage 202 is also referred to as “client data storage.”

As illustrated in FIG. 2, data storage 202 contains program instructions 210, user data 212, a client identifier 214, and a server identifier 216. Program instructions 210 may comprise computer-readable program instructions that are executable by processor 200. While the present disclosure does not include the actual program instructions 210, such program instructions can be written in light of the disclosure by a person having ordinary skill in the art. Program instructions 210 may be written in any one of a number of suitable computer programming languages.

As an example, program instructions 210 may include program instructions executable by processor 200 to (i) determine that a user has requested a given file contained in user data 212, (ii) determine time-to-live data that is contained in data user data 212 and that is associated with the given file, and (iii) determine whether the time-to-live data associated with the given file has expired.

Program instructions 210 may include program instructions that are executable by processor 200 in response to processor 200 determining that the time-to-live data has not expired. As an example, these program instructions may include instructions that (i) cause processor 200 to request that data storage 202 provide the given file to user interface 204, and (ii) cause user interface 204 to present the given file to a user of client 104.

Program instructions 210 may include program instructions executable by processor 200 in response to processor 200 determining that the time-to-live data has expired. As an example, these program instructions may include instructions that (i) cause processor 200 to generate hash request message 600, (ii) cause network interface 206 to transmit hash request message 600 to server 102 via communication network 108, and (iii) cause processor 200 to determine whether a hash provided in hash response message 700 matches a hash associated with the given file.

Program instructions 210 may include program instructions executable by processor 200 in response to processor 200 determining that the hash in hash response message 700 matches the hash associated with the given file (e.g., a hash stored at client 104 prior to client 104 receiving the hash response message 700. As an example, these program instructions may include instructions that (i) cause processor 200 to request that data storage 202 provide the given file to user interface 204, and (ii) cause user interface 204 to present the given file to a user of client 104.

Program instructions 210 may include program instructions executable by processor 200 in response to processor 200 determining that the hash in hash response message 700 does not match the hash associated with the given file (e.g., a hash stored at client 104 prior to client 104 receiving the hash response message 700). As an example, these program instructions may include instructions that (i) cause processor 200 to generate a file request message 800, (ii) cause network interface 206 to send file request message 800 to server 102 via communication network 108, and (iii) cause user interface 204 to present to a user of client 104 a file contained in file transmission message 900. Other examples of program instructions 210 are also possible, some of which are describe below.

User data 212 may include any of the user data described herein. As an example, user data 212 may include assembly parts data, data files arranged as any of the various file types described herein or other file types that may be downloaded to client 104 from server 102, and metadata. User data 212 may include initial user data that is provided to client 104 from server 102, from a compact disc read only memory (CD ROM) or a digital video disc (DVD), or from another data source. User data 212 may also include updated data provided by server 102 via communication network 108.

Client identifier 214 may include an identifier of client 104, and server identifier 216 may include an identifier of server 102. As an example, client identifier 214 may include an Internet Protocol (IP) address that is associated with client 104, and server identifier 216 may include an IP address that is associated with server 102. Additionally or alternatively, client identifier 214 may include a media access control (MAC) address that is associated with client 104, and server identifier 216 may include a media access control (MAC) address that is associated with server 102. Other examples of client identifier 214 and source identifier 216 are also possible.

User interface 204 may include any of a variety of elements that are operable and/or useable by a user to input data into client 104 and/or to receive data that may be presented to a user of client 104. As an example, user interface 204 may include a display, such as a liquid crystal display (LCD), an organic light emitting diode (OLED) display, a plasma display, a cathode ray tube (CRT) display, or some other type of display. The display is operable to display at least a portion of user data 212.

As another example, user interface 204 may include a disc drive, such as a CD drive and/or a DVD drive, that is operable to transfer data from a disc inserted into the disc drive to data storage 202. At least a portion of the data stored in data storage 202 (e.g., initial user data) may have been transferred from the disc drive to data storage 202.

As yet another example, user interface 204 may include a keyboard and/or mouse for manually entering data into client 104. The manually entered data may, for example, include a user selection of a given page-file-type file, a given image, or a given hot spot. Other examples of elements that may be included as part of user interface 204 to manually enter data are also possible.

As still yet another example, user interface 204 may include a graphical user interface (GUI). The GUI may be operable to display an image (e.g., an image-file type file) and allow a user to select hot spots associated with the displayed image. After selecting a given hot spot, the GUI may display information of a page-file-type file that is associated with the given hot spot. Other examples of operability of user interface 204 are also possible

For purposes of this description, a network interface, such as network interface 206, is operable as an interface to communication network 108. The network interface may be arranged as a network interface card (NIC) and/or a modem such as a cable modem, a digital subscriber line (DSL) modem, a broadband over power line (BPL) modem, or another type of modem. Network interface 206 may be operable to transmit messages, such as hash request message 600 and file request message 800, according to any of a variety of communication protocols, such as the Transmission Control Protocol/Internet Protocol (TCP/IP) or some other communication protocol. Network interface 206 may also be operable to receive messages, such as hash response messages 700, 702, and file transmission message 900, and thereafter provide the received messages or data contained within the received messages to another element of client 104, such as processor 200 and/or data storage 202 via connection mechanism 208.

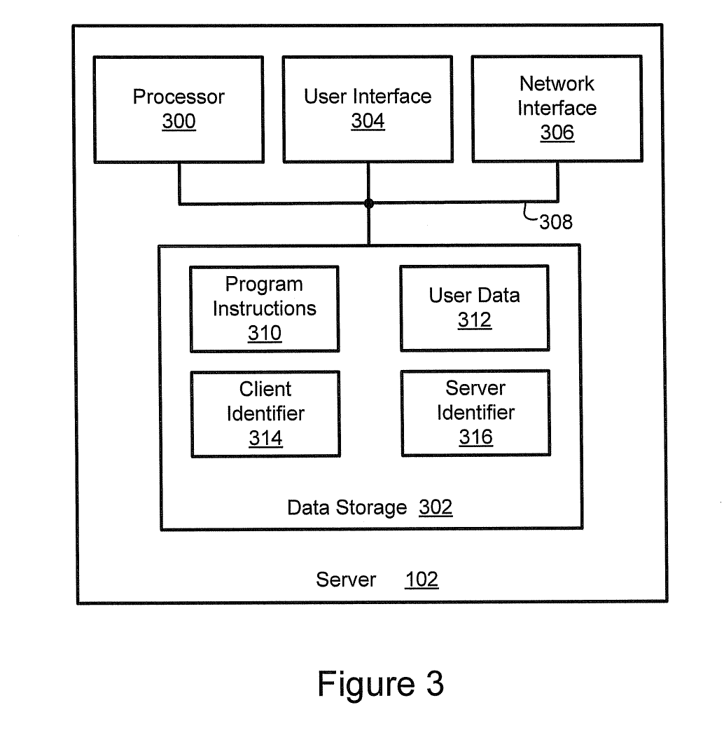

Next, FIG. 3 depicts a block diagram illustrating details of server 102. As depicted in FIG. 3, server 102 may include a processor 300, data storage 302, a user interface 304, and a network interface 306, all of which may be linked together via a system bus, network, or other connection mechanism 308. For purposes of this description, data storage 302 is also referred to as “server data storage.” An exemplary system and/or apparatus may include server 102 or any elements of server 102.

Data storage 302 may contain various types of data. For example, data storage 302 may contain (i) computer-readable program instructions 310, (ii) user data 312, (iii) a client identifier 314, and (iv) a server identifier 316. Program instructions 310 may comprise computer-readable program instructions that are executable by processor 300. While the present disclosure does not include the actual program instructions 310, such program instructions can be written in light of the disclosure by a person having ordinary skill in the art. Program instructions 310 may be written in any one of a number of suitable computer programming languages.

As an example, program instructions 310 may include program instructions executable by processor 300 to cause network interface 306 to transmit initial user data to clients 104, 106.

Program instructions 310 may include program instructions that are executable by processor 300 in response to network interface 306 and, in turn, processor 300 receiving hash request message 600. As an example, these program instructions may include instructions that (i) cause processor 300 to retrieve from data storage 312 the hash associated with the current version of the file identified in hash request message 600, (ii) cause processor 300 to generate hash response message 700 (or hash response message 702), and (iii) cause network interface 306 to transmit hash response message 700 (or hash response message 702) to client 104 via communication network 108.

Program instructions 310 may include instructions that are executable by processor in response to network interface 306 and, in turn, processor 300 receiving file request message 800. As an example, these program instructions may include instructions that (i) cause processor 300 to retrieve from data storage 312 the file identified in file request message 800, (ii) cause processor 300 to generate file transmission message 900, and (iii) cause network interface 306 to transmit file transmission message 900 to client 104 via communication network 108. Other examples of program instructions 310 are also possible.

User data 312 may include any of the user data described herein. As an example, user data 312 may include assembly parts data, data files arranged as any of the various file types described herein or other file types that may be downloaded to client 104 from server 102, and metadata. User data 312 may include initial user data and/or updated data that may be provided to client 104 via communication network 108.

Client identifier 314 may include identifiers of one or more clients, such as an identifier of client 104 and/or an identifier of client 106. Server identifier 316 may include an identifier of server 102. As an example, client identifier 314 may include an Internet Protocol (IP) address that is associated with client 104, and server identifier 316 may include an IP address that is associated with server 102. Additionally or alternatively, client identifier 314 may include a media access control (MAC) address that is associated with client 104, and server identifier 316 may include a media access control (MAC) address that is associated with server 102. Other examples of client identifier 314 and source identifier 316 are also possible.

User interface 304 may include any of a variety of elements that are operable and/or useable by a user to input data into server 102 and/or to receive data that may be presented to a user of server 102. As an example, user interface 304 may include a display, such as a display that is operable to display at least a portion of user data 312. As another example, user interface 304 may include a keyboard and/or mouse for manually entering data into server 102. The manually entered data may, for example, include a modified TTL value associated with a given file maintained in user data 312. Other examples of elements that may be included as part of user interface 304 to manually enter data are also possible.

Network interface 306 is operable as an interface to communication network 108. Network interface 306 may be operable to transmit messages, such as hash response messages 700, 702 and file transmission message 900, according to any of a variety of communication protocols, such as the Transmission Control Protocol/Internet Protocol (TCP/IP) or some other communication protocol. Network interface 306 may also be operable to receive messages, such as hash request message 600 and file request message 800.

### 3. Exemplary Communications

Next, FIG. 6 depicts an exemplary hash request message 600 that may be transmitted to server 102 from client 104 via communication network 108. Hash request message 600 may include a destination identifier 602 (i.e., an identifier of the message destination), a source identifier 604 (i.e., an identifier of the message source), a message content identifier 606, and a file identifier 608.

As shown in FIG. 6, hash request message 600 includes a hash request for the carburetor1.tiff file. Client 104 is the source of hash request message 600 and server 102 is the destination of the hash request message. A person having ordinary skill the art will understand that hash request message 600 may include other information such as a message header or some other information.

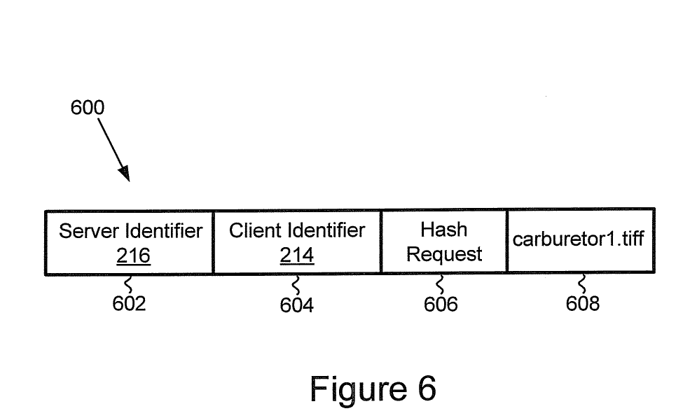

Next, FIG. 7 depicts exemplary hash response messages 700, 702 that may be transmitted from server 102 to client 104 via communication network 108. Hash response messages 700, 702 may each include a destination identifier 602, a source identifier 604, a message content identifier 606, a file identifier 608, and a hash 610 that is associated with the file identified by file identifier 608.

As shown in FIG. 7, hash response message 700 indicates that the hash associated with the file “carburetor1.tiff” is 3C4F10A8. In this case and in accordance with the data shown in Table 2, the hash at server 102 matches the hash at client 104. Thus, the most-current version of the file “carburetor1.tiff” is being maintained at client data storage 202. On the other hand, hash response message 702 indicates that the hash associated with the file “carburetor1.tiff” is 4D258BC0. In this case and in accordance with the data shown in Table 2, the hash at server 102 does not match the hash at client 104. Thus, the client data storage 202 does not contain the most-current version of the file “carburetor1.tiff.” A person having ordinary skill the art will understand that hash response messages 700, 702 may include other information such as a message header or some other information.

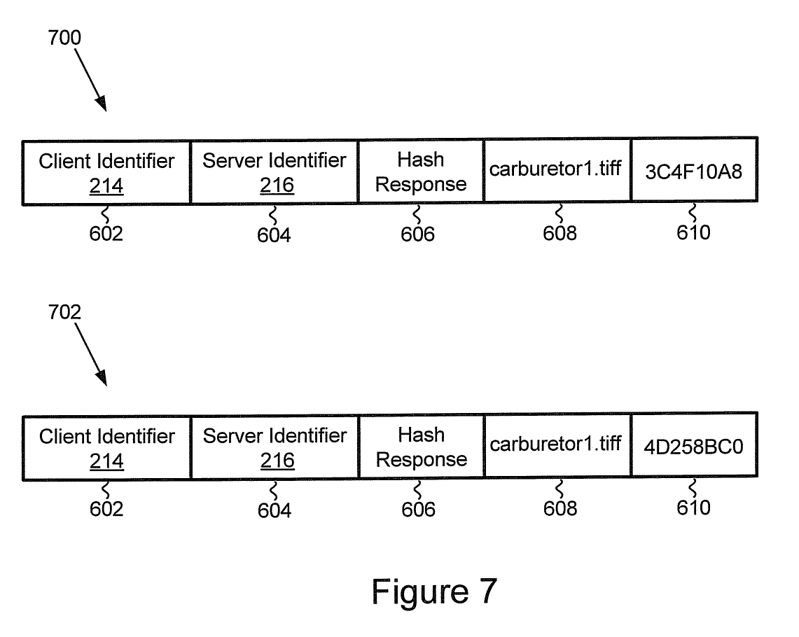

Next, FIG. 8 depicts an exemplary file request message 800 that may be transmitted from client 104 to server 102 via communication network 108. File request message 800 may include a destination identifier 602, a source identifier 604, a message content identifier 606, and a file identifier 608. A person having ordinary skill the art will understand that file request message 800 may include other information such as a message header or some other information.

As shown in FIG. 8, the message content identifier 606 comprises a file request and the file identifier 608 identifies the “carburetor1.tiff” file. Client 104 is the source of file request message 800 and server 102 is the destination of the file request message 800. The file request message 600 thus provides a request for server 102 to provide client 104 with the “carburetor1.tiff” file.

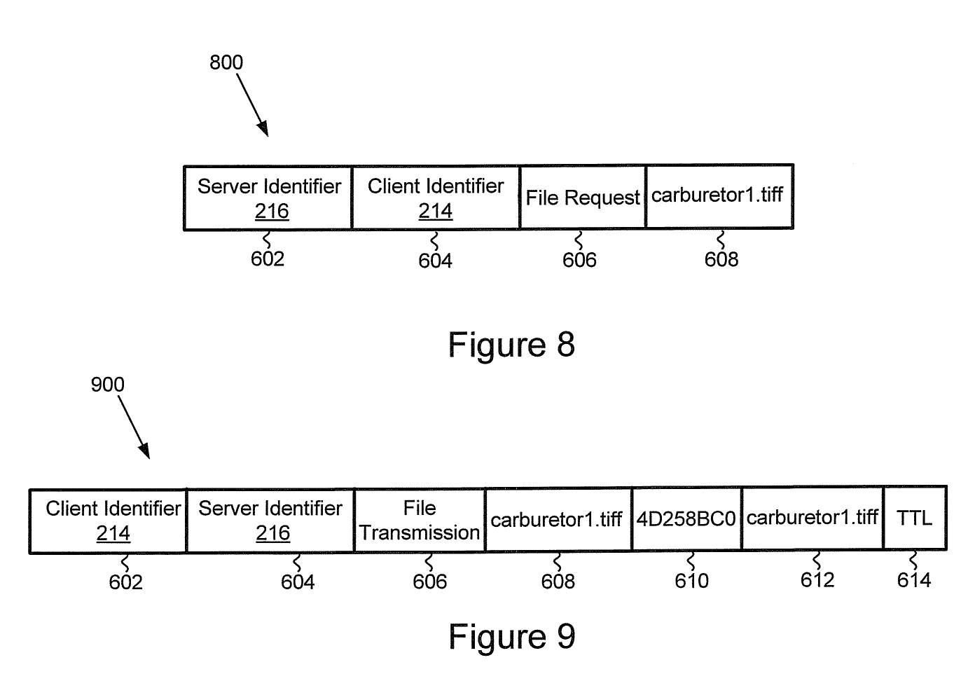

Next, FIG. 9 depicts an exemplary file transmission message 900 that may be transmitted from server 102 to client 104 via communication network 108. File transmission message 900 may include a destination identifier 602, a source identifier 604, a message content identifier 606, a file identifier 608, a hash 610, a file or a portion of a file 612, and time-to-live data 614. A person having ordinary skill the art will understand that file transmission message 900 may include other information such as a message header or some other information.

As shown in FIG. 9, the file or a portion of a file 612 file includes the “carburetor1.tiff” file or at least a portion of the “carburetor1.tiff” file. In the case in which file transmission message 900 includes only a portion of the transmitted file, server 102 may transmit one or more additional file transmission messages, each additional message including a respective portion of the file being transmitted to client 104. TTL data 614 may include TTL data that is associated with the file 612. TTL data 614 may have a value that is the same as the TTL data stored at data storage 202 for the file identified by file identifier 608 or that differs from the TTL data stored at data storage 202 for the file identified by file identifier 608. Server 102 is the source of file transmission message 900 and client 104 is the destination of the file transmission message 900.

In an alternative embodiment, hash 610 and/or TTL data 614 may be omitted from file transmission message 900. In accordance, with this alternative embodiment, client 104 may use hash 610 of hash response message 702 to update user data 212 with an updated hash that is associated with an updated file transmitted via file transmission message 900. Further, and in accordance with this alternative embodiment, server 102 may not provide updated TTL data. In this regard, for example, the TTL data provided with an initial data file may be the only TTL data provided for the initial data file and any updated versions of the data file.

### 4. Exemplary Operation

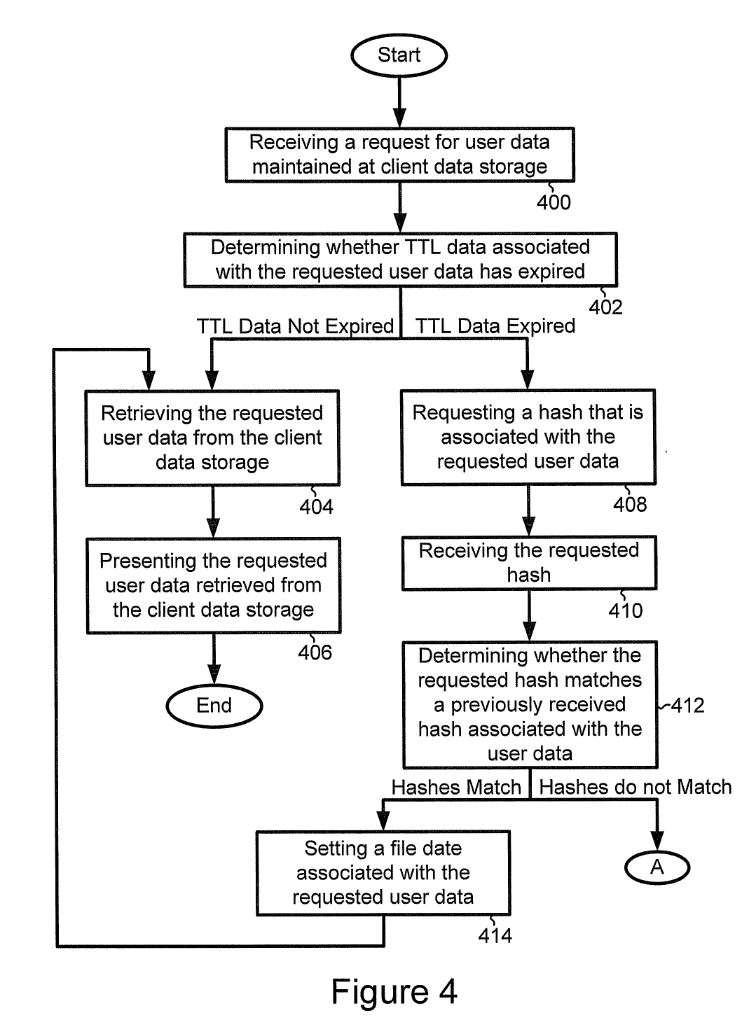

Next, FIGS. 4 and 5 are flow charts provided to illustrate a set of functions that may be carried out in accordance with an exemplary embodiment of the present invention. The functions shown in FIGS. 4 and 5 may be carried out in a sequential order as shown in the figures, or in another order. Additionally, two or more of the functions shown in FIGS. 4 and 5 may be carried out simultaneously.

As shown in FIG. 4, block 400 includes receiving a request for user data maintained at client data storage. For purposes of this description, the request for user data will be referred to as a “user request.” The user request may be received at processor 200 in response to a user selecting a given portion of user data 212 via user interface 204. As an example, the user request may comprise a request to view the image of a given assembly, such as a request to view the image of the file identified as “carburetor1.tiff.” A client user may enter the user request in various ways, such as clicking on a hot spot that is associated with the “carburetor1.tiff” file. This hot spot may be displayed via user interface 204 while user interface 204 is displaying the “carburetor.1.page” file.

Next, block 402 includes determining whether the TTL data associated with the requested user data has expired. Processor 200 may execute program instructions 210 to make the determination. As an example, execution of the program instructions may cause processor 200 to (i) request the file date (e.g., Jan. 1, 2009) that is associated with the requested user data (e.g., the “carburetor1.tiff” file), (ii) add the amount of time identified by the TTL data (e.g., 30 days) to the file date to obtain a TTL expiration date (e.g., Jan. 31, 2009), and (iii) compare the TTL expiration date (e.g., Jan. 31, 2009) with the date on which the user request was made. If the TTL expiration date has not yet passed (i.e., the user request was made before Jan. 31, 2009), the determination may be that the TTL data is not expired. On the other hand, if the TTL expiration date has passed (i.e., the user request was made on or after Feb. 1, 2009), the determination may be that the TTL is expired.

If the determination of block 402 is that the TTL data is not expired, an exemplary method may next include carrying out the function of block 404. Block 404 includes retrieving the requested user data from the client data storage 202. Retrieving the requested user data may include processor 200 executing program instructions 210 to read the data maintained at a given set of data addresses of data storage 202, the given set of addresses corresponding to the location in data storage 202 where the requested user data is maintained. Additionally or alternatively, retrieving the requested user data may include processor 200 executing program instructions 210 to cause data storage 202 to provide the requested user data to user interface 204 for subsequent and/or simultaneous presentation of the requested user data.

Next, block 406 includes presenting the requested user data retrieved from the client data storage 202. Presenting the requested user data may include processor 200 executing program instructions 210 that cause a display of user interface 204 to present the user data retrieved from data storage 202. If all of the retrieved user data cannot be displayed via the display at a given time, user interface 204 may include a selection mechanism that causes a non-displayed portion of the retrieved user data to be displayed.

Returning to block 402, if the determination of block 402 is that the TTL data is expired, an exemplary method may next include carrying out the function of block 408. Block 408 includes requesting a hash that is associated with the requested user data. Requesting the hash may include transmitting the hash request message 600 from client 104 to server 102. Processor 200 may execute program instructions 210 that cause network interface 206 to transmit the hash request message 600 to communication network 108 for transmission, in turn, to server 102.

Server 102, and in particular network interface 306 and then processor 300, may receive hash request message 600. In response to receiving the hash request message 600, processor 300 may execute program instructions 310 to retrieve a hash that is associated with a file identified by file identifier 608. For example, if file identifier 608 identifies the “carburetor1.tiff” file, processor 300 may retrieve the hash 3C4F10A8 from user data 312. The file date in the second row of Table 2 indicates that the file date associated with the “carburetor1.tiff” file is Jan. 1, 2009. If the server 102 has updated the “carburetor1.tiff” file or has received an updated version of the “carburetor1.tiff” file on or after Jan. 1, 2009, the hash associated with the updated version of the “carburetor1.tiff” file may be 4D258BC0 or some other hash. In this latter case, processor 300 retrieves the hash 4D258BC0.

In response to retrieving the hash, processor 300 may execute program instructions 310 that (i) cause processor 300 to generate a hash response message, such as hash response message 700 or hash response message 702, and (ii) cause network interface 306 to transmit the hash response message to client 104 via communication network 108.

Next, block 410 includes receiving the requested hash. Receiving the requested hash may be carried out at client 104. In particular, receiving the requested hash may include network interface 206 receiving the hash response message 700 from server 102. In response to receiving the hash response message 700, network interface 206 may provide processor 200 with the hash response message 700 and processor 200 may then execute program instructions 210 to extract the requested hash from hash response message 700. Processor 200 may execute program instructions 210 that cause data storage 202 to store the requested hash in data storage 202. Storing the requested hash may be carried out in addition to maintaining a previously-received hash that is associated with the requested user data.

Next, block 412 includes determining whether the requested hash matches a previously received hash associated with the requested user data. The previously received hash comprises a hash that was received by client 104 prior to client 104 receiving the requested hash via hash response message 700. The previously received hash may be received via another response message. Processor 200 may execute program instructions 210 that cause processor 200 to determine whether the requested hash matches the previously received hash.

If the determination of block 412 is that the requested hash matches the previously received hash (i.e., the hashes match), an exemplary method may next include carrying out the function of block 414. Block 414 includes setting a file date associated with the requested user data. Processor 200 may execute program instructions 210 that cause processor 200 to set the file date. For example, if a user enters the “user request” on Feb. 18, 2009, then processor 200 may execute program instructions 210 that cause the file date associated with “carburetor1.tiff” file to be set to Feb. 18, 2009. In this regard, if a user of client 104 subsequently requests the “carburetor1.tiff” file, a determination whether the TTL data associated with the “carburetor1.tiff” file is expired is based on the most recently set file date (e.g., Feb. 18, 2010) for the “carburetor1.tiff” file.

If the determination of block 412 is that the requested hash does not match the previously received hash (i.e., the hashes do not match), an exemplary method may next include carrying out the function of block 416. As illustrated in FIG. 5, block 416 includes requesting updated user data. Requesting the updated user data may include processor 200 executing program instructions 210 to (i) cause processor 200 to generate file request message 800, and (ii) cause network interface 206 to transmit file request message 800 to communication network 108 for transmission, in turn, to server 102.

Server 102, and in particular network interface 306 and then processor 300, may receive file request message 800. In response to receiving file request message 800, processor 300 may execute program instructions 310 to retrieve the updated data or at least a portion of the updated data from data storage 302. Processor 300 may execute program instructions 310 that (i) cause processor 300 to generate one or more file transmission messages that are arranged as file transmission message 900, and (ii) cause network interface 306 to transmit the one or more file transmission messages to communication network 108 for transmission, in turn, to client 104.

Next, block 418 includes receiving the updated user data. Receiving the updated user data may include network interface 206 receiving the updated user data as transmitted via communication network 108 from client 102. As an example, receiving the updated user data may include client 104 receiving file transmission message 900. Receiving file transmission message 900 may include receiving a plurality of packets that have been encoded with the file transmission message 900. If the updated user data includes more than a given amount of data (e.g., a given amount of data that may be placed into one file transmission message), receiving the updated user data may include receiving a plurality of file transmission messages. Each file transmission message may include a sequence identifier for use in reconstructing the updated user data from portions of updated user data transmitted in a plurality of data packets and/or via two or more file transmission messages.

Next, block 420 includes setting a file date associated with the received updated user data. Processor 200 may execute program instructions 210 that cause processor 200 to set the file date. For example, if the updated user data contains the data identified as the “carburetor1.tiff” file, and if the updated user data is received on Feb. 18, 2010, then processor 200 may execute program instructions that cause the file date associated with “carburetor1.tiff” file to be set to Feb. 18, 2010. In this regard, if a user of client 104 subsequently requests the “carburetor1.tiff” file, a determination whether the TTL data associated with the “carburetor1.tiff” file is expired may be based on the most recently set file date (e.g., Feb. 18, 2010) for the “carburetor1.tiff” file.

Next, block 422 includes storing the updated user data in the client data storage 202. Processor 200 may execute program instructions 210 that cause processor 200 and/or network interface 206 to provide the updated user data to data storage 202 and that cause processor 200 to direct data storage 202 to store the updated user data at a given set of data addresses of data storage. Processor 200 may store additional data (e.g., data pointers) associated with the given set of data addresses for use in recalling the given set of addresses when the updated user data is to be retrieved from data storage 202.

Next, block 424 includes retrieving the updated user data from the client data storage 202. Retrieving the updated user data may include processor 200 executing program instructions 210 to read the updated data stored at a given set of data addresses of data storage 202, the given set of addresses corresponding to the location in data storage 202 where the updated user data is stored. A previous version of the user data may have been stored at the given set of addresses prior to storage of the updated user data at the given set of addresses. Additionally or alternatively, retrieving the updated user data may include processor 200 executing program instructions 210 to cause data storage 202 to provide the updated user data to user interface 204 for subsequent and/or simultaneous presentation of the updated user data.

Next, block 426 includes presenting the updated user data retrieved from the client data storage 202. Presenting the requested updated user data may include processor 200 executing program instructions 210 that cause a display of user interface 204 to present the updated user data retrieved from data storage 202. If all of the updated user data cannot be displayed via the display at a given time, user interface 204 may include a selection mechanism that causes a non-displayed portion of the updated user data to be displayed.

### 5. Additional Examples

a. Time-to-Live (TTL) Data

The TTL data may be specified in any of a variety of units of time. As illustrated in the examples above, the TTL data is specified as some number of days. Alternatively or additionally, the TTL data may be specified as some number of minutes, hours, months, years, or some other unit of time. The various files stored in data storage 202, 302 do not have to be associated with TTL data specified in the same units of time. For example, data storage 202, 302 may include a first file that is associated with TTL data specified as a given number of days, and a second file that is associated with TTL data specified as a given number of hours.

b. Comparing Hashes

In the examples above, in response to client 104 receiving a user request, client 104 sends to server 102 hash request message 600 and server 102 responds to hash request message 600 by sending one of hash response messages 700, 702 to client 104. Thereafter, client 104 compares a previously received hash to the hash contained in the hash response message sent to client 104, and if the hashes do not match, client sends server 102 file request message 800. In alternative embodiments, in response to client 104 receiving a user request, client 104 may send to server 102 a message including (i) the hash that is associated with a given file, and (ii) the file identifier that is associated with the given file. In response to receiving the hash and the file identifier, server 102 may compare the hash sent in the message to the hash that is associated with the latest version of the given file and that is stored at data storage 302. If the hashes match, server 102 responsively provides client 104 with notification that the hashes match and client 104 presents the given file that is stored in data storage 202. On the other hand, if the hashes do not match, server 102 responsively sends an updated version of the given file to client 104. Thereafter, client 104 may present the updated version of the given file to a user of client 104 via user interface 204.

c. Updating a Hash

As indicated above, file transmission message 900 may not include hash 610. In this case, client 104 may receive an updated hash via hash response message 702. Processor 200 may execute program instructions 210 that cause processor 200 to determine that the hash received in hash response message 702 is associated with the file transmitted via file transmission message 900. As an example, processor 200 may detect that hash response message 702 and file transmission message 900 each include an identical file identifier and processor 200 may responsively associate the hash received in hash response message 702 with the file transmitted via file transmission message 900. Processor 200 may cause the updated hash to be stored as user data 212 in place of a previously-received hash associated with a version of the file identified by file identifier 608.

d. On-Line/Off-Line Operation

In accordance with the exemplary embodiments, a client (e.g., client 104) may operate in an on-line mode in which client 104 can transmit and/or receive communications via communication network 108, and in an off-line mode in which client 104 cannot transmit and/or receive communications via communication network 108. Processor 200 may execute program instructions 210 that cause client 104 to switch from operating in the on-line mode to the off-line mode and to switch from operating in the off-line mode to the on-line mode. Switching the client to operate in the off-line mode may allow a user of the client to reduce its expenses for being connected to network 108, transmitting communications via network 108, and/or receiving communications via network 108.

As an example, processor 200 may execute program instructions 210 to switch client 104 from the off-line mode to the on-line mode in response to determining that the hashes compared in block 412 do not match. As another example, processor 200 may execute program instructions 210 to switch client 104 from the on-line mode to the off-line mode in response to determining that client 104 has received the entire file being transmitted by file transmission message 900. Other examples of processor executing program instructions that cause client 104 to switch to the on-line mode or the off-line mode are also possible.

e. Data Compression and Decompression

In accordance with the exemplary embodiments described herein, at least a portion of the communications transported between server 102 and client 104, such as a portion of file transmission message 900, may comprise compressed user data. In particular and by way of example, the file or the portion of the file 612 may comprise compressed user data. Program instructions 310 may comprise program instructions that cause processor 300 to compress at least a portion of user data 312 prior to and/or as file transmission message 900 is being generated.

In one respect, in response to server 102 receiving file request message 800, processor 300 may execute program instructions 310 that (i) cause processor 300 to compress at least a portion of user data 312 and insert the compressed user data into file transmission message 900 as the file or portion of the file 612, and (ii) cause network interface 306 to transmit the file transmission message 900, including the compressed user data, to communication network 108 for transmission, in turn, to client 104.

In another respect, at least a portion of user data 312 may comprise compressed user data. In this way, in response to server 102 receiving file request message 800, processor 300 may execute program instructions 310 that (i) cause processor 300 to insert at least a portion of compressed user data 312 into file transmission message 900, and (ii) cause network interface 306 to transmit the file transmission message 900, including the compressed user data, to communication network 108 for transmission, in turn, to client 104.

Each client that receives compressed user data, such as client 104, may comprise program instructions to decompress the compressed used data. As an example, program instructions 210 may comprise program instructions executable by processor 200 to decompress compressed user data that may be contained in file transmission message 900 or another message communicated to client 104 from server 102. After decompression of the user data, the decompressed user data may be stored as user data 212 and subsequently presented to a user of client 104.

As an example, the program instructions for compressing and/or decompressing user data may comprise program instructions arranged as (i) a version of zlib produced by Jean-loup Gailly and Mark Adler, such as zlib version 1.2.3, (ii) a version of WinZip® produced by WinZip International LLC, such as WinZip® version 11.2, (iii) or some other program instruction for compressing and/or decompressing files and/or user data.

f. Data Security

In accordance with the exemplary embodiments described herein, at least a portion of the communications transported between server 102 and client 104, such as a portion of file transmission message 900, may comprise encrypted user data. In particular and by way of example, the file or the portion of the file 612 may comprise encrypted user data. Program instructions 310 may comprise program instructions that cause processor 300 to encrypt at least a portion of user data 312 prior to and/or as file transmission message 900 is being generated.

In one respect, in response to server 102 receiving file request message 800, processor 300 may execute program instructions 310 that (i) cause processor 300 to encrypt at least a portion of user data 312 and insert the encrypted user data into file transmission message 900 as the file or portion of the file 612, and (ii) cause network interface 306 to transmit the file transmission message 900, including the encrypted user data, to communication network 108 for transmission, in turn, to client 104.

In another respect, at least a portion of user data 312 may comprise encrypted user data. In this way, in response to server 102 receiving file request message 800, processor 300 may execute program instructions 310 that (i) cause processor 300 to insert at least a portion of encrypted user data 312 into file transmission message 900, and (ii) cause network interface 306 to transmit the file transmission message 900, including the encrypted user data, to communication network 108 for transmission, in turn, to client 104.

Each client that receives encrypted user data, such as client 104, may comprise program instructions to decipher (e.g., decode and/or decrypt) the encrypted used data. As an example, program instructions 210 may comprise program instructions executable by processor 200 to decipher encrypted user data that may be contained in file transmission message 900 or another message communicated to client 104 from server 102. After deciphering the user data, the deciphered (e.g., unencrypted) user data may be stored as user data 212 and subsequently presented to a user of client 104.

Furthermore, the encrypted user data may comprise compressed user data and/or the encrypted used data may be compressed prior to transmission from server 102 to client 104.

### CONCLUSION

Example embodiments arranged as a system and method are described above. Those skilled in the art will understand, however, that changes and modifications may be made to these examples without departing from the true scope and spirit of the described systems and methods. The embodiments described in this description and the accompanying drawings are set forth for illustration and not as a limitation.

We claim:

1. A method comprising:
at data storage of a client, maintaining (i) a first version of a data file, (ii) a file identifier that identifies the data file, (iii) a time-to-live indicator that is associated with the data file, and (iv) a first hash that is associated with the first version of the data file;
receiving a first request for the data file;
in response to receiving the first request for the data file, determining whether the time-to-live indicator has expired, wherein in response to determining that the time-to-live indicator has not expired, presenting the first version of the data file to a requester of the data file, otherwise, in response to determining that the time-to-live indicator has expired, transmitting a hash request to a server, and
the client, after transmitting the hash request, receiving from the server the first hash, and then, responsively presenting the first version of the data file via a user interface.

2. The method of claim 1, further comprising:
receiving a second request for the data file;
in response to receiving the second request for the data file, determining that the time-to-live indicator has expired and responsively re-transmitting the hash request to the server,
the client, after re-transmitting the hash request, receiving from the server a second hash and determining that the first hash and second hash are different, and thereafter, responsively transmitting to the server a request for an updated version of the data file; and
the client, after transmitting the request for updated version of the data file, receiving from the server a second version of the data file, and thereafter, presenting the second version of the data file via the user interface.

3. The method of claim 2, further comprising:
the client, in response to receiving the second version of the data file, storing in the data storage a time indicator that indicates when the client received the second version of the data file;
the client, receiving a second hash from the server, wherein the second hash is associated with the second version of the data file, and
at the data storage of the client, maintaining the second version of the data file and the second hash.

4. A method comprising:
at data storage of a client, maintaining (i) a first version of a data file, (ii) a file identifier that identifies the data file, (iii) a time-to-live indicator that is associated with the data file, and (iv) a first hash that is associated with the first version of the data file;
receiving a first request for the data file;
in response to receiving the first request for the data file, determining whether the time-to-live indicator has expired, wherein in response to determining that the time-to-live indicator has not expired, presenting the first version of the data file to a requestor of the data file, otherwise, in response to determining that the time-to-live indicator has expired, transmitting to a server the file identifier and the first hash; and
the client, after transmitting the file identifier and the first hash, receiving from the server an indication that the first version of the data file is a latest version of the data file, and then, responsively presenting the first version of the data file via a user interface.

5. The method of claim 4, further comprising:
receiving a second request for the data file;
in response to receiving the second request for the data file, determining that the time-to-live indicator has expired and responsively transmitting to the server the file identifier and the first hash,
the client, after transmitting the file identifier and the first hash, receiving from the server a second version of the data file, and thereafter, responsively presenting the second version of the data file via the user interface.

6. The method of claim 5, further comprising:
the client, in response to receiving the second version of the data file, storing in the data storage a time indicator that indicates when the client received the second version of the data file;
the client, receiving a second hash from the server, wherein the second hash is associated with the second version of the data file, and
at the data storage of the client, maintaining the second version of the data file and the second hash.

7. The method of claim 4, further comprising:
at the client, prior to maintaining the data file at the data storage of the client, receiving from the server the data file, the file identifier, and the hash.
